(19) United States
(12) Patent Application Publication
(10) Pub. No.: US 2004/0072600 A1
(43) Pub. Date: Apr. 15, 2004

(54) Cheat verification system and method for a video games system

(75) Inventor: David Darling, Southam (GB)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: The Codemasters Software Company Limited, Southam (GB)

(21) Appl. No.: 10/644,464

(22) Filed: Aug. 20, 2003

(30) Foreign Application Priority Data
Aug. 20, 2002 (GB) 0219420.7

(51) Int. Cl. A63F 13/00

(52) U.S. Cl. 463/1; 463/41

(57) ABSTRACT

The cheat verification system includes a remote cheatline which a player can contact by telephone. The cheatline has a processor 5 containing ID codes identifying player-selectable cheats. A player obtains a bonus code from the games console and supplies the bonus code to the cheatline operator. The player selects a cheat from a number of available options and the processor 5 combines the corresponding ID code with the bonus code according to an encryption process to generate a verification code which is supplied to the player. The player inputs the verification code to the console where it is decrypted enabling the bonus code and the ID code to be recovered under the control of verification software in the video game. Provided the bonus code derived from the verification code matches the bonus code obtained by the player from the games console the selected cheat will be implemented.

This invention relates to video games systems, particularly the verification of cheats in video game systems.

A cheat is used to modify an existing video game with a view to changing the game play. A player can obtain a cheat from a cheatline which he can contact by telephone. The cheatline operator asks the player to select a cheat from a range of available options and provides the player with a cheat code for the cheat that he selects. The player inputs the cheat code to his video games console using a control pad or the like and the video games console then implements the cheat by adapting appropriate game parameters to effect the desired changes.

Usually, a cheatline will have been authorised by the publisher of the video game. However, it is also possible for a player to obtain cheats from unauthorised sources such as magazines which routinely publish cheat codes. This is undesirable because a cheat obtained in this way might not have been approved by the game publisher.

According to the invention there is provided a cheat verification system for enabling a video games console to implement a cheat for a video game, the cheat being identifiable by identification data, the cheat verification system including, means for applying a predetermined process to said identification data to generate verification data, and verification software, stored in the video game, for enabling the video games console to implement said cheat in response to said verification data.

Embodiments of the invention are now described, by way of example only, with reference to the accompanying drawings of which:

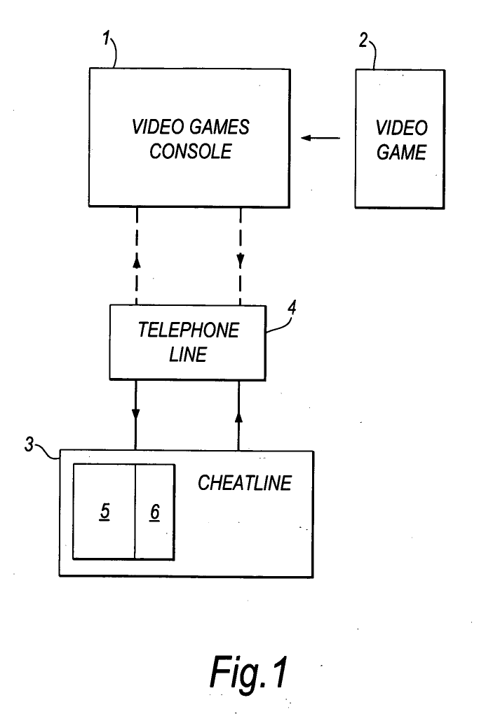

FIG. 1 is a block schematic representation of a cheat verification system according to the invention, and

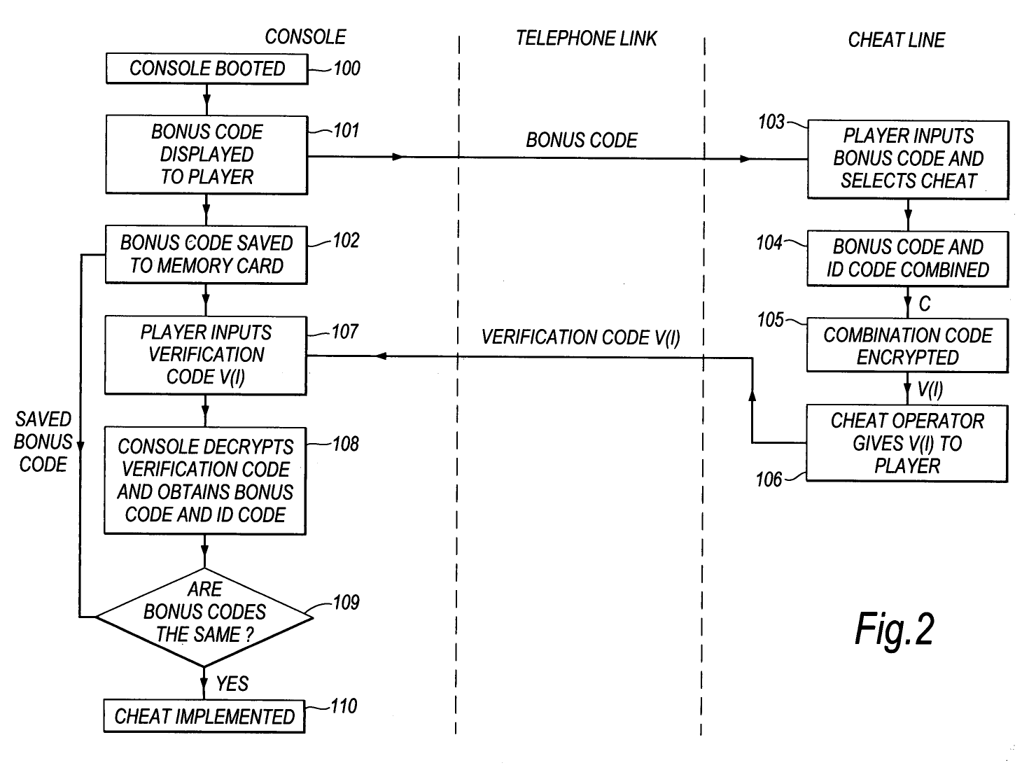

FIG. 2 is a schematic flow diagram illustrating one implementation of a cheat verification system according to the invention.

FIG. 1 shows a video games console 1, a video game 2 which is to be played on the video games console 1 and a cheatline 3 at a remote location which can be contacted by a player over a telephone line 4. It will be understood that the term video games console is intended to include a personal computer on which a video game can be played.

A player can contact the cheatline 3 to request access to a cheat which will assist the player in subsequent game play. In response to the request, the cheatline operator gives the player the appropriate cheat code which the player must input to the video games console 1 using a control pad or the like. The video games console 1 may then implement the cheat by modifying appropriate game parameters.

Usually, a cheatline operating in this manner will be controlled or authorised by the game publisher. However, as already described, it is also possible for a player to obtain cheat codes from sources that have not been authorised by the game publisher e.g. magazines, instead of contacting an authorised cheatline. This practice is undesirable because such sources might not have been approved by the game publisher.

As will now be described, a cheat verification system according to the present invention is intended to deny a video games console authority to implement cheats obtained from unauthorised sources.

To this end the cheat verification system includes verification software stored in the video game 2 and a cheatline processor 5 having a memory 6. Operation of a preferred implementation of the cheat verification system will now be described with reference to the flow diagram of FIG. 2.

When a video game 2 is loaded into the video games console 1, the console 1 is initially booted (step 100) and the player is allocated authorisation data. In this implementation of the cheat verification system the authorisation data allocated to the player consists of a bonus code which is displayed to the player by the video games console 1 on a bonus screen (step 101). In this example, the bonus code consists of a four digit number, giving 10⁴ possible combinations, although bonus codes consisting of larger or smaller numbers than this could alternatively be used. The verification software stored in the video game causes the video games console 1 to save the bonus code to a memory card for future use (step 102). In a preferred implementation of the cheat verification system the bonus code is a number which is randomly generated by the video games console at the player's request. Alternatively, the bonus code could be a number that has been prestored in the video games console.

When the player contacts cheatline 3 over telephone line 4 the cheatline operator will ask the player for the four digit bonus code that has been allocated to him, and he will be required to select a cheat from a range of available options (step 103).

The game publisher allocates, in advance, different identification data that identify different player-selectable cheats. In this implementation of the invention, the identification data has the form of a two digit identity (ID) code. Thus, for example, a cheat requesting race cars to drive only in reverse might be allocated ID code “01”, whereas a cheat providing turbo boost might be allocated ID code “02”. These ID codes are prestored in memory 6 of processor 5 and are also made available to the video games console 1 by the verification software stored in the video game 2. However, the ID codes are not made available to the player.

When the player selects a cheat from the options presented to him by the cheatline operator, processor 5 combines the four digit bonus code and the corresponding two digit ID code in such a way that the bonus code and the ID code can still be recognised (step 104). For example, if the four digit bonus code is [0000] and the two digit ID code is [01], the resultant combination code C might be [00000]. In this case, the first four digits of the combination code are the same as the bonus code and the last two digits of the combination code are the same as the ID code.

The processor 5 then encrypts the combination code C using a secret encryption algorithm to generate verification data which, in this embodiment, has the form of a six digit verification or unlock code V(I) (step 105). The verification code V(I) is given to the player (step 106), and because the encryption algorithm used to generate the verification code is secret the player is unable to discover the ID code corresponding to the cheat that has been selected.

The player is required to input the verification code V(I) to the video games console using a key pad or similar data entry device (step 107), and the verification software stored in the video game 2 causes the video games console 1 to decrypt the verification code V(I) using a complementary secret decryption algorithm to recover the combination code ([000001], in the above example) (step 108). The bonus code formed by the first four digits of the combination code is then compared with the bonus code previously saved to the memory card (step 109), and provided that these codes are the same the video games console 1 is enabled by the verification software to implement the cheat corresponding to the ID code formed by the last two digits of the combination code (step 110).

If the two bonus codes are different, or the ID code formed by the last two digits of the combination code does not match one of the ID codes made available to the video games console 1 by the verification software, a cheat will not be implemented.

Because neither the encryption/decryption algorithms, nor the two digit ID codes are known to the player, it is impossible for the player independently to generate the verification code V(I) which the player must input to the video games console before a cheat can be implemented. Therefore, the described cheat verification system ensures that the video games console 1 will only implement cheats that have been obtained from an authorised cheatline.

In an alternative implementation of the invention, the verification code V(I) generated by cheatline processor 5 is input to the video games console 1 by the player together with information identifying the cheat that has been selected. The verification software stored in the video game 2 causes the video games console 1 to subject the player's bonus code (previously saved to memory card) and the two digit ID code corresponding to the selected cheat to exactly the same processing as that carried out by processor 5 using the same secret encryption algorithm to generate a second six digit verification code V(II). The second six digit verification code V(II) is then compared with the six digit verification code V(I) generated by processor 5 and input to the video games console 1 by the player. Provided the compared verification codes V(I) and V(II) are the same, the video games console is enabled to implement the cheat; otherwise, the cheat cannot be implemented.

It will be appreciated that in an alternative embodiment the cheatline processor 5 could be directly connected to the video games console 1, via an Internet link, for example, enabling the player to exchange data using a key pad or similar data entry device.

It will also be appreciated that a cheat verification system of the kind described may be a source of revenue for the cheatline provider. More specifically, each time a connection is made using a telecommunications link the network operator levies a charge on the player and the cheatline operator may also receive a revenue stream.

It will be understood that whereas some of above-described processing is carried out by the cheatline processor 5, it is alternatively possible for all the processing to be carried out by the video games console 1 itself under the control of software, including the verification software, stored in the video game, although software instructions for generating the verification code V(I) could be obtained from a location remote from the video games console; for example, on-line from a remote website.

I claim as my invention:

1. A cheat verification system for enabling a video games console to implement a cheat for a video game, the cheat being identifiable by identification data, the cheat verification system including,
means for applying a predetermined process to said identification data to generate verification data, and
verification software, stored in the video game, for enabling the video games console to implement said cheat in response to said verification data.

2. The cheat verification system as claimed in claim 1 wherein said predetermined process is applied to said identification data by processing means at a location remote from said video games console.

3. The cheat verification system as claimed in claim 2 wherein said processing means is part of a cheatline.

4. The cheat verification system as claimed in claim 1 wherein said predetermined process is applied to said identification data by said video games console.

5. The cheat verification system as claimed in claim 4 wherein software instructions for applying said predetermined process to said identification data are obtained from a location remote from the video games console.

6. The cheat verification system according to claim 1 wherein said predetermined process includes combining said identification data with authorisation data allocated to a player by the video games console to generate combination data, and encrypting the combination data to generate said verification data.

7. The cheat verification system as claimed in claim 6 wherein said verification software is arranged to cause the video games console to decrypt said verification data, obtain identification data and authorisation data from the decrypted verification data, and implement the cheat, identifiable by the identification data obtained from the decrypted verification data, provided the authorisation data obtained from the decrypted verification data is the same as the authorisation data allocated to the player.

8. The cheat verification system as claimed in claim 6 wherein said verification software is arranged to cause said authorisation data allocated to the player to be saved to a memory card of the video games console.

9. The cheat verification system as claimed in claim 6 wherein said predetermined process is applied by processing means at a location remote from said video games console and authorisation data allocated to the player is supplied to said processing means via a communications link.

10. The cheat verification system as claimed in claim 9 wherein said processing means is part of a cheatline and said communications link is a telecommunications link.

11. The cheat verification system as claimed in claim 6 wherein said authorisation data is a randomly generated number.

12. The cheat verification system as claimed in claim 6 wherein said authorisation data is a number that has been prestored in the video games console.

13. The cheat verification system as claimed in claim 1 wherein said verification software is arranged to cause said video games console to apply a further predetermined process to identification data corresponding to said cheat to generate further verification data, said predetermined processes having a predetermined relationship, compare the verification data generated by the respective predetermined processes and enable the video games console to implement said cheat in dependence on the comparison.

14. The cheat verification system as claimed in claim 13 wherein said predetermined processes are identical and said verification software enables the video games console to implement the cheat provided the compared verification data are the same.

15. The cheat verification system as claimed in claim 13 wherein said predetermined processes include application of an encryption algorithm.

16. The cheat verification system as claimed in claim 1 for enabling the video games console to implement different player-selectable cheats for the video game, the different player-selectable cheats being identifiable by different respective said identification data.

17. The cheat verification system as claimed in claim 1 wherein said predetermined process is applied by processing means at a location remote from said video games console, and said verification data generated by said processing means is supplied to said video games console by a player.

18. The cheat verification system as claimed in claim 1 wherein said predetermined process is applied by processing means at a location remote from said video games console, and said verification data generated by said processing means is supplied to said video games console over a communications link.

19. The cheat verification system as claimed in claim 18 wherein said communications link directly interconnects said processing means and said video games console.

20. The cheat verification system as claimed in claim 19 wherein said communications link is an Internet link.

21. The cheat verification system as claimed in claim 1 wherein said identification data is not available to a player.

22. The cheat verification system as claimed in claim 6 wherein said authorisation data is a four digit number.

23. The cheat verification system as claimed in claim 1 wherein said identification data is a two digit number.

24. The cheat verification system as claimed in claim 1 wherein said verification software includes said identification data.

25. The cheat verification system as claimed in claim 1 wherein said predetermined process is applied to said identification data by processing means at a location remote from said video games console, and said identification data is prestored in said processing means.

26. A video game said including verification software for use in said cheat verification system as claimed in claim 1.

27. A cheat verification method for enabling a video games console to implement a cheat for a video game, the cheat being identifiable by identification data, the cheat verification method including the steps of applying a predetermined process to said identification data to generate verification data, and
enabling the video games console to implement said cheat in response to said verification data.

28. The cheat verification method as claimed in claim 27 wherein said predetermined process is applied to said identification data at a location remote from said video games console.

29. The cheat verification method as claimed in claim 28 wherein said predetermined process is applied to said identification data by processing means at said location being part of a cheat line.

30. The cheat verification method as claimed in claim 27 wherein said predetermined process is applied to said identification data by said video games console.

31. The cheat verification method as claimed in claim 30 including obtaining software instructions for applying said predetermined process to said identification data from a location remote from said video games console.

32. The cheat verification method as claimed in claim 31 wherein said location is a website.

33. The cheat verification method as claimed in claim 27 wherein said predetermined process includes combining said identification data with authorisation data allocated to a player by the video games console to generate combination data, and encrypting the combination data to generate said verification data.

34. The cheat verification method as claimed in claim 33 wherein said enabling step includes using verification software stored in said video game to cause the video games console to decrypt said verification data, obtain identification data and authorisation data from the decrypted verification data and implement said cheat, identifiable by the identification data obtained from the decrypted verification data, provided the authorisation data obtained from the decrypted verification data is the same as the authorisation data allocated to the player.

35. The cheat verification method as claimed in claim 34 wherein said verification software is used to cause said authorisation data allocated to the player to be saved to a memory card of the video games console.

36. The cheat verification method as claimed in claim 33 wherein said predetermined process is carried out at a location remote from the video games console and said authorisation data allocated to the player is supplied to said location via a communications link.

37. The cheat verification method as claimed in claim 33 wherein said authorisation data is a randomly generated number.

38. The cheat verification method as claimed in claim 33 wherein said authorisation data is a number that has been prestored in the video games console.

39. The video game including software arranged to enable a video games console in which the video game has been loaded to carry out at least said enabling step of the cheat verification method according to claim 27.

40. The video game as claimed in claim 39 wherein said software enables the video games console to apply said predetermined process to said identification data to generate said verification data.
